(19) United States
(12) Patent Application Publication
(10) Pub. No.: US 2020/0323721 A1
(43) Pub. Date: Oct. 15, 2020

(54) Integrated Dental Care System

(71) Applicant: Madappa Belliappa Puttichanda, Bangalore (IN)

(72) Inventor: Madappa Belliappa Puttichanda, Bangalore (IN)

(21) Appl. No.: 16/444,337

(22) Filed: Jun. 18, 2019

(30) Foreign Application Priority Data
Apr. 15, 2019 (IN) 201941015065

(51) Int. Cl. A61G 15/00; A61C 17/022; A61C 17/06; A61C 17/14; A61G 15/16

(52) U.S. Cl. CPC A61G 15/002; A61C 17/022; A61G 15/16; A61C 17/14; A61C 17/06

(57) ABSTRACT

An integrated dental care system is provided. The integrated dental care system comprises a dental recliner chair. The dental recliner chair includes a folding frame. The folding frame includes a U-shaped rear leg frame pivotally coupled to a U-shaped front leg frame. The dental recliner chair also includes two side arms. The dental recliner chair also includes a chair frame. The integrated dental care system also includes a dental treatment unit. The dental treatment unit includes a central body. The dental treatment unit also includes of an integrated compressor and suction unit. The dental treatment unit also includes a plurality of tubes. The dental treatment unit also includes a detachable tool box. The detachable tool box is configured to store a plurality of equipment. The dental treatment unit also includes an adjustable handle and a plurality of wheels. Present disclosure provides a low cost, dependable and portable dental clinic.

### CROSS-REFERENCE TO RELATED APPLICATION

This application claims the benefit of complete patent application having Patent Application No. 201941015065 filed on Apr. 15, 2019 in India.

### FIELD OF INVENTION

Embodiments of a present disclosure relates to mobile dental clinic, and more particularly to an integrated dental care system having a portable chair and a portable tool box.

### BACKGROUND

Primary use of dental clinic is to prevent complications such as tooth decay (cavities) and gum disease and to maintain the overall health of mouth. Regular dental chair and dental tool are not mobile. Usually the dental chair and compressor and suction unit are placed at a particular place in a dental clinic. So, the patient has to visit the dental clinic for dental service. According to World Health Organisation (WHO) a child must visit a dentist once in 6 months and an adult once a year.

In conventional approach, a person has to visit a dental clinic at regular times. The clinic facilities are permanently fixed in a particular place. More effective service would be to provide mobile dental clinic. Here, the dental tools and the dental chair should be accessible to all kinds of people. Moreover, the permanently fixed and bulky arrangement of dental instrument surely makes the installation cost very high. So, a low cost, dependable and easy to move dental instruments would surely enable the dentist in providing service.

Hence, there is a need for an improved integrated dental care system to address aforementioned issues.

### BRIEF DESCRIPTION

In accordance with one embodiment of the disclosure, an integrated dental care system is provided. The integrated dental care system comprises a dental recliner chair. The dental recliner chair includes a folding frame. The folding frame includes a U-shaped rear leg frame pivotally coupled to a U-shaped front leg frame. The dental recliner chair also includes two side arms. The two side arms are configured to slide up and slide down over a pivot point of the U-shaped rear leg frame and the U-shaped front leg frame respectively.

The dental recliner chair also includes a chair frame. The chair frame is mechanically coupled with the folding frame, comprising a seat supporting frame, a back-supporting frame, and a leg supporting frame and a head resting frame. Here, inclination angle of the chair frame is mechanically adjusted when the two side arms are slide up over the pivot point of the U-shaped rear leg frame and the U-shaped front leg frame respectively. The dental recliner chair also includes a. plurality of serrated edge mechanically coupled to the two side arms for sliding process. The dental recliner chair also includes a slider locking mechanism, which is mechanically coupled to the seat supporting frame and the leg supporting frame for mechanical adjustment.

The integrated dental care system also comprises a dental treatment unit. The dental treatment unit includes a central body. The dental treatment unit also includes of an integrated compressor and suction unit. The dental treatment unit are configured to provide dry⁻ air for dental treatment. The dental treatment unit are configured to provide a. pathway for suctioning out waste fluid.

The dental treatment unit also includes a plurality of tubes. The plurality of tubes is mechanically coupled to the central body. The plurality of tubes is configured to provide a pathway for flow of fluid. The dental treatment unit also includes a detachable tool box. The detachable tool box is centrally fixed to the central body. The detachable tool box is configured to store a plurality of equipment. The dental treatment unit also includes an adjustable handle and a plurality of wheels. The adjustable handle and the plurality of wheels is mechanically coupled to the central body. Here, the adjustable handle and the plurality of wheels is configured to provide easy mechanism to handle the central body. The dental treatment unit also includes a ventilator unit. The ventilator unit is mechanically coupled to the side of the central body. The ventilator unit is configured to ventilate the heated air out from the integrated compressor and suction unit.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a diagrammatic representation of an embodiment representing an integrated dental care system in accordance with an embodiment of the present disclosure;

FIG. 2 is a diagrammatic representation of an embodiment representing the portable dental recliner chair in accordance with an embodiment of the present disclosure;

FIG. 3 is a side-view diagrammatic representation of an embodiment representing the portable dental recliner chair in accordance with an embodiment of the present disclosure;

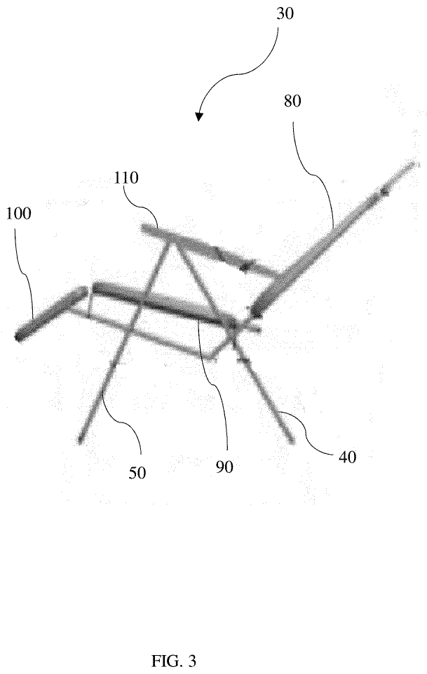

FIG. 4 is a different angular representation of an embodiment representing the portable dental recliner chair in accordance with an embodiment of the present disclosure;

FIG. 5 is a representation of an embodiment representing a dental treatment unit in accordance with an embodiment of the present disclosure;

FIG. 6 is a representation of an embodiment representing a detachable tool box of the dental treatment unit in accordance with an embodiment of the present disclosure;

FIG. 7 is an inside-view representation of an embodiment representing the dental treatment unit in accordance with an embodiment of the present disclosure; and

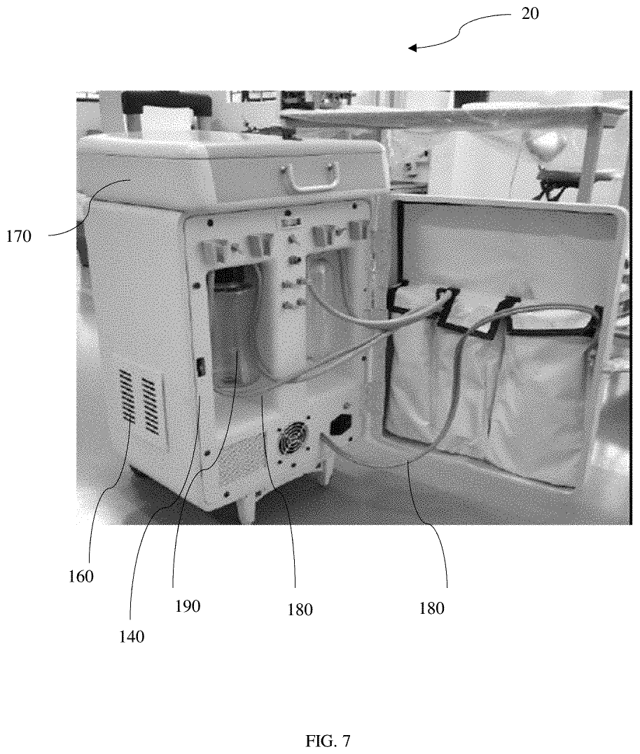

FIG. 8 is a representation of an embodiment representing the spittoon bowl and bottle in accordance with an embodiment of the present disclosure;

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, and “the” include plural references unless the context clearly dictates otherwise.

Embodiments of the present invention relates to an integrated dental care system. The integrated dental care system comprises a dental recliner chair. The dental recliner chair includes a folding frame. The folding frame includes a U-shaped rear leg frame pivotally coupled to a U-shaped front leg frame. The dental recliner chair also includes two side arms. The two side arms are configured to slide up and slide down over a pivot point of the U-shaped rear leg frame and the U-shaped front leg frame respectively.

The dental recliner chair also includes a chair frame. The chair frame is mechanically coupled with the folding frame, comprising a seat supporting frame, a back-supporting frame, and a leg supporting frame and a head resting frame. Here, inclination angle of the chair frame is mechanically adjusted when the two side arms are slide up over the pivot point of the U-shaped rear leg frame and the U-shaped front leg frame respectively. The dental recliner chair also includes a plurality of serrated edge mechanically coupled to the two side arms for sliding process. The dental recliner chair also includes a slider locking mechanism, which is mechanically coupled to the seat supporting frame and the leg supporting frame for mechanical adjustment.

The integrated dental care system also comprises a dental treatment unit. The dental treatment unit includes a central body. The dental treatment unit also includes of an integrated compressor and suction unit. The dental treatment unit are configured to provide dry air for dental treatment. The dental treatment unit are configured to provide a pathway for suctioning out waste fluid.

The dental treatment unit also includes a plurality of tubes. The plurality of tubes is mechanically coupled to the central body. The plurality of tubes is configured to provide a pathway for flow of fluid. The dental treatment unit also includes a detachable tool box. The detachable tool box is centrally fixed to the central body. The detachable tool box is configured to store a plurality of equipment. The dental treatment unit also includes an adjustable handle and a plurality of wheels. The adjustable handle and the plurality of wheels is mechanically coupled to the central body. Here, the adjustable handle and the plurality of wheels is configured to provide easy mechanism to handle the central body. The dental treatment unit also includes a ventilator unit. The ventilator unit is mechanically coupled to the side of the central body. The ventilator unit is configured to ventilate the heated air out from the integrated compressor and suction unit.

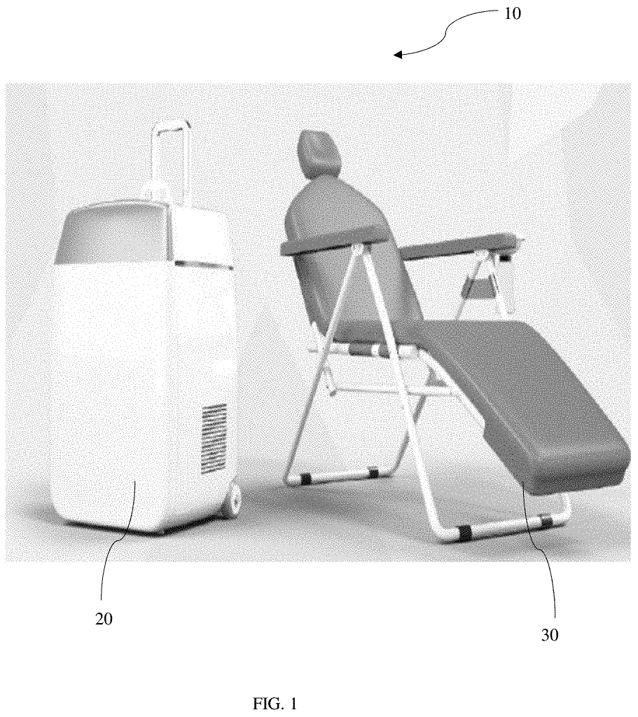

FIG. 1 is a diagrammatic representation of an embodiment representing an integrated dental care system 10 in accordance with an embodiment of the present disclosure. As used herein, “the dental care system” refers to total oral dental healthcare. The dental care system includes a dental recliner chair 30 and a dental treatment unit 20.

In one embodiment, the dental recliner chair 30 is foldable and easily moved in a carry bag. In such embodiment the dental recliner chair 30 is of recliner nature and weighs only in the range of 12 kilograms.

In another embodiment, the dental treatment unit 20 is basically a compact equipment or tool box. In such embodiment, the portable dental treatment unit 20 weighs only 24 kilograms. The portable dental treatment unit 20 is about the height of 2.5 feet, width 1.5 feet and depth of 1.25 feet. The dental treatment unit 20 is basically a movable suitcase on wheels and enabled to be carried on back.

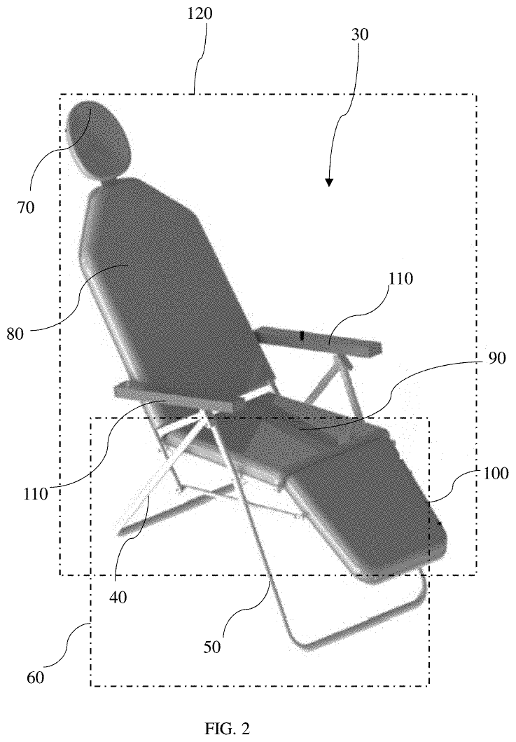

FIG. 2 is a diagrammatic representation of an embodiment representing a portable dental recliner chair 30 in accordance with an embodiment of the present disclosure. As used herein, the term “portable” means to be easily carried or moved, especially because being of a lighter and smaller version than usual. In one embodiment, the dental recliner chair 30 is referred to the chair on which a patient sits comfortably during check-up or operations. In another embodiment, the term “recliner” means a chair with a reclining back, especially one with an integral footrest.

The portable dental recliner chair 30 includes a folding frame 60. The folding frame 60 comprises a U-shaped rear leg frame pivot 40 coupled to a U-shaped front leg frame 50. As used herein, the term “frame” refers to a rigid structure that surrounds the whole structure of chair.

Here, in one embodiment, the U-shaped rear leg frame 40 and the U-shaped front leg frame 50 is composed of plastic material. In such embodiment, the frames join together at both sides to form a pivot joining. As used herein, the term “folding frame” refers to a frame which foldable in particular direction, to enable easy storage and movement.

The portable dental recliner chair 30 also includes two side arms 110. The two side arms 110 are configured to slide up and slide down over a pivot point of the U-shaped rear leg frame 40 and the U-shaped front leg frame 50 respectively. In one such embodiment, the two side arms 110 are permanently placed over the pivoted joints of the U-shaped rear leg frame 40 and the U-shaped front leg frame 50. In another such embodiment, the two side arms 110 may exhibit vertical up and down direction movement. As used herein, the “side arms” refer to portion of chair that enables resting of arms.

The portable dental recliner chair 30 also includes a chair frame 120. The chair frame 120 is mechanically coupled with the folding frame 60, comprising a seat supporting frame 90, a back-supporting frame 80, and a leg supporting frame 100 and a head resting frame 70. As used herein, the term “chair frame” refers to a frame on which the patient sits. In one embodiment, the seat supporting frame 90 is referred to the portion of the chair on which a patient may sit. In another embodiment, the back-supporting frame 80 is referred to the portion of the chair in which the patient may rest back during check-up or operations.

In another embodiment, the leg supporting frame 100 is referred to the portion of the chair on which the patient may rest leg during check-up or operations. In another embodiment, the head resting frame 70 is referred to the portion of the chair on which the patient may rest head during check-up or operations.

Furthermore, in one embodiment, the inclination angle of the chair frame (120) is mechanically adjusted when the two side arms 110 are slide up over the pivot point of the U-shaped rear leg frame 40 and the U-shaped front leg frame 50 respectively. In such embodiment, the mechanical adjustment may differ from patient to patient according to the dresses or individual height. In an exemplary embodiment, women wearing traditional dresses may find the chair easy to sit in a comfortable way.

The portable dental recliner chair 30 also includes a plurality of serrated edge mechanically coupled to the two side arms 110 for sliding process. In one embodiment, the plurality of the serrated edge enables in adjusting of the two side arms 110 by sliding and hooking over the plurality of the serrated edges. As used herein, the term “serrated edges” refers to edges that has been lined with small teeth, similar to a saw's. In such embodiment, the serrated edge fixation gives extra protection, as the dental recliner chair 30 is dislocated while it is in use. In yet another embodiment, the side arm 110 enables folding of the dental recliner chair 30.

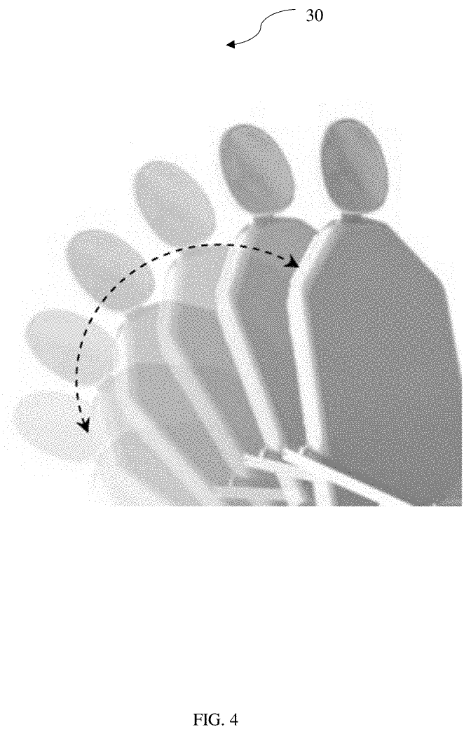

The portable dental recliner chair 30 also includes a slider locking mechanism, which is mechanically coupled to the seat supporting frame 90 and the leg supporting frame 100 for mechanical adjustment. In one such embodiment, the slider locking mechanism enables various angular adjustment of the seat supporting frame and the leg supporting frame. Here, the slider provides user specific angle adjustment. (as shown in FIG. 4)

In one embodiment, a soft fabric nylon cloth contour is being used in the making of portable dental recliner chair 30 for reverse pressure. The portable dental recliner chair 30 is designed to provide low centre of gravity for stability. Moreover, in another embodiment, the portable dental recliner chair 30 may also provide 160-degree angle of inclination.

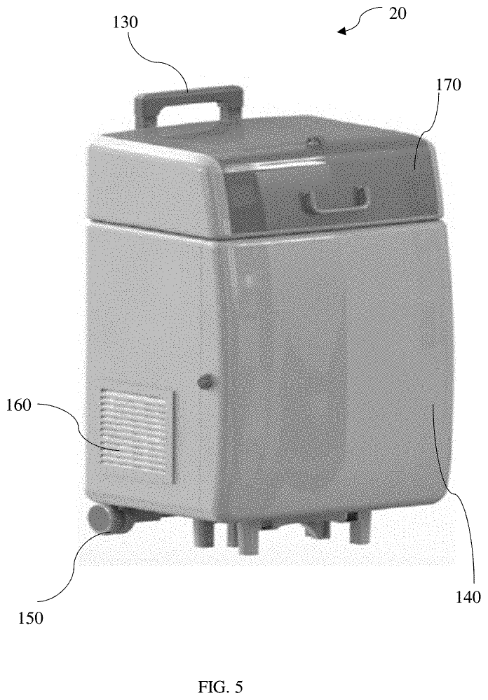

FIG. 5 is a representation of an embodiment representing a dental treatment unit 20 in accordance with an embodiment of the present disclosure. The dental treatment unit 20 includes a central body 140. As used herein, “dental treatment” refers medical care given to a patient for an illness or injury related to teeth. In one embodiment, the dental treatment unit 20 has width in the range of 1.5 feet. In another embodiment, the dental treatment unit has height in the range of 2.5 feet.

In one embodiment, the dental treatment unit 20 refers to a portal, easy carrying box, specially designed to carry all needed medical instruments. In one embodiment, the central body 140 may be locked by hinges to provide protection to the cavity carrying the medical equipment. in such embodiment, a front panel is hinged to the central body 140. In another embodiment, a front panel is locked by a “door lock”, configured to lock the front panel.

In one exemplary embodiment, the central body 140 is fabricated with Fiberglass Reinforced Plastics (FRP) material, Such fabrication enables long life and less maintenance.

The dental treatment unit 20 also includes of an integrated compressor and suction unit as sub unit. The integrated compressor and suction unit are configured to provide dry air for dental treatment. The integrated compressor and suction unit are also configured to provide a pathway for suctioning out waste fluid. Here, the waste fluid comprises saliva, blood, debris from the mouth and the like.

In one embodiment, compressor generates 8 bar pressure, here, 2 bar pressure is enabled to operate the dental tools and 5 bar pressure is enabled for rapid suction of saliva. As used herein, the term “bar” is a metric unit of pressure.

In an exemplary embodiment, a dentist specifically needs the compressed air, vacuum, and water at the dental recliner chair when performing dental procedures, the integrated compressor and suction unit is specifically designed to make such instrument available to the dentist. In one embodiment, the integrated compressor and suction unit is small enough to be fitted in the portable unit. Moreover, the compressor unit is mounted on the frame to prevent noise and vibration.

Furthermore, in one embodiment, the compressor unit allows the dentist to provide dry air for drying teeth after surgery, in such embodiment, drying is vital to be oil-free drying. In another embodiment, the suction unit allows suctioning out waste fluid. In such embodiment, various types of ejector are being used for this purpose.

The dental treatment unit 20 also includes a plurality of tubes 180. The plurality of tubes 180 is mechanically coupled to the central body 140. The plurality of tubes 180 is configured to provide pathway for flow of fluid. In one embodiment, the plurality of tubes 180 is connected to the corresponding plurality of equipment. In such embodiment, the plurality of equipment comprises at least one of a high-speed handpiece, a low-speed handpiece, 3-way syringe, saliva ejector, a plurality of bottle, wherein the plurality of bottle 190 comprises bottles from at least one of a clean water system, air supply system and waste collection system. In one exemplary embodiment, the plurality of tubes 180 is fabricated with disposable plastic material,

As used herein, the term “high-speed handpiece” refers to a handheld dental cutting instrument that rotates at up to 450,000 Revolutions per minute (RPM), powered by miniature turbines and driven by compressed air or an electric motor. As used herein, the term “low-speed handpiece” refers to an electric or air-powered handpiece that typically operates at 60,000 Revolutions per minute (RPM) or lower, used for general cutting, grinding and polishing.

As used herein, the term “3-way syringe” refers to syringe having separate internal channels supplying air, water or a mist created by combining the pressurized air with the waterflow. Here, a syringe tip can be separated from the main body and replaced when necessary. As used herein, the term “saliva ejectors” refers to vacuum cleaners for mouth, whereby narrow tubes that dentists and other oral health care professionals use for suction of saliva, blood and debris from the mouth.

In one embodiment, the clean water system enables providing purified water or distilled water. Here, the plurality of bottle 190 is used to store the purified water or the distilled water. In another embodiment, the waste collection system comprises a plurality of bottles, that are cleaned easily when needed.

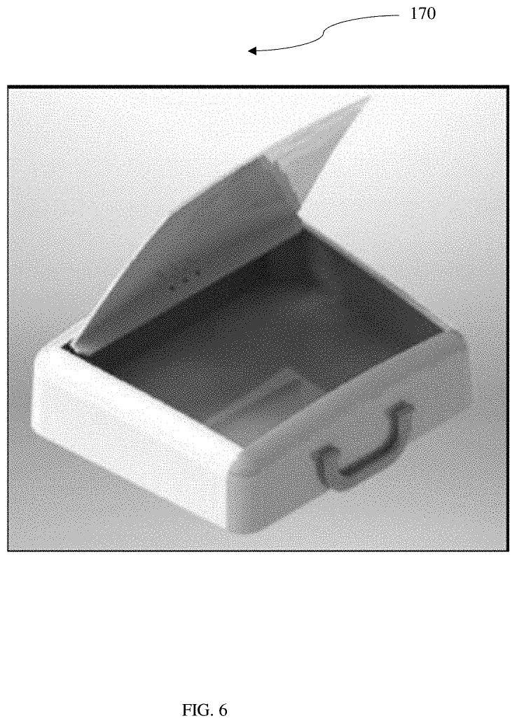

The dental treatment unit 20 also includes a detachable tool box 170. The detachable tool box 170 is centrally fixed to the central body 140. The detachable tool box 170 is configured to store a plurality of equipment. In one embodiment, the detachable tool box 170 is configured in such a way that the tools are easily stored in the tool box. (as shown in FIG. 6)

The dental treatment unit 20 also includes an adjustable handle 130 and a plurality of wheels 150. The adjustable handle 130 and the plurality of wheels 150 is mechanically coupled to the central body 140. In one embodiment, the adjustable handle 130 and the plurality of wheels 150 is configured to provide easy mechanism to handle the central body 140. In such embodiment, the plurality of wheels 150 are located on the two corners of the dental treatment unit for easy movement.

The dental treatment unit 20 also includes a ventilator unit 160. The ventilator unit 160 is mechanically coupled to the side of the central body 140. The ventilator unit 160 is configured to ventilate the heated air out from the integrated compressor and suction unit. In one embodiment, the ventilator unit prevents the dental treatment unit 20 from getting heated up while continuous use. In another embodiment, ventilation system to ensure cooling and cross ventilation.

The dental treatment unit 20 further comprises an electrical subsystem configured to provide electricity to the electrical driven systems. In one embodiment, the flow of electricity is controlled by a plurality of toggle switches. In such embodiment, every medical equipment is to be controlled by the plurality of toggle switches. Here, a plurality of indicators is being used to indicate a particular equipment of the plurality of equipment is being in use.

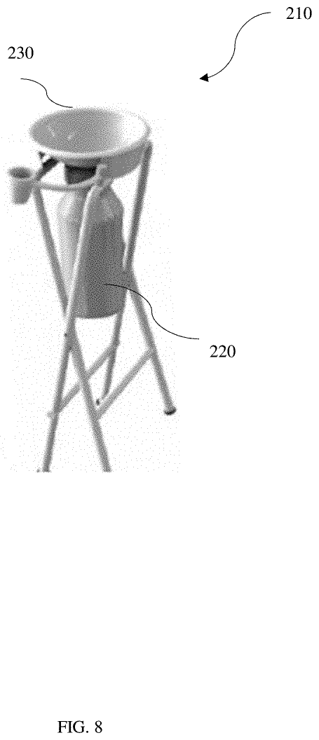

The dental recliner chair 30 further comprises a spittoon bowl 230 and bottle 220. The spittoon bowl 230 and bottle 220 are physically stored the central body 140. The spittoon bowl 230 and bottle 220 is mechanically coupled to the dental recliner chair. The spittoon bowl 230 and bottle 220 are configured to store saliva waste water. As used herein, “spittoon” refers to a metal or earthenware pot typically having a funnel-shaped top, used for spitting into. (as shown in FIG. 8)

In operation, a patient may use a portable dental recliner chair 30 for resting. Here, the patient may adjust the inclination angle of the chair frame 120 by mechanically adjusting the two side arms 110 over the pivot point by pulling up or down the two side arms 110.

Moreover, in one exemplary embodiment, the patient pushes the back-supporting frame 80 backward which in turn pushes the leg supporting frame 100 forward. Both, the back-supporting frame 80 and leg supporting frame 100 enables proper movement simultaneously. A doctor may use the plurality of equipment stored in the dental treatment unit like a high-speed handpiece, a low-speed handpiece, 3-way syringe, saliva ejector, a plurality of bottle 190, wherein the plurality of bottle comprises bottles from at least one of clean water system, air supply system and waste collection system.

Here, the compressor unit allows the dentist to provide dry air for drying teeth after surgery. And, the suction unit allows suctioning out waste fluid. Also tube pouches are present to provide a holder for collecting the waste fluid.

Present disclosure of integrated dental care system provides a portable dental clinic. The dental recliner chair is a portable, rigid and foldable chair for dental surgery usage. The dental recliner chair provides angular adjustment of seats between seat supporting frame and leg supporting frame, the feature enables user of different height to easily adjust according to need. Patient with traditional dresses may also easily adjust on the portable dental recliner chair.

Moreover, the present disclosure also provides a dental treatment unit provides a compact and a portable tool box. The dental treatment unit is fabricated with Fiberglass Reinforced Plastics (FRP) material to provide a long life with less maintenance. Here, the unit comprises a sub unit of an integrated compressor and suction unit, for providing all required facilities during operations,

Further, a clean water system, an air supply system and a waste collection system are also provided to enable proper medical facilities. Here, all the additional systems are fabricated inside the dental treatment unit. Additional equipment like pressure gauge and the like are retro fitted inside the dental treatment unit for usage which makes the dental treatment unit portable. Present disclosure of integrated dental care system may be used along with digital platform for dental care services.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. An integrated dental care system 10, comprising:
a dental recliner chair 30, comprising:
a folding frame 60 which comprises a U-shaped rear leg frame 40 pivotally coupled to a U-shaped front leg frame 50;
two side arms 110 configured to slide up and slide down over a pivot point of the U-shaped rear leg frame 40 and the U-shaped front leg frame 50 respectively;
a chair frame 120 mechanically coupled with the folding frame 60, comprising a seat supporting frame 90, a back-supporting frame 80 and a leg supporting frame 100 and a head resting frame 70_{;}
wherein an inclination angle of the chair frame 120 is mechanically adjusted when the two side arms 110 are slide up over the pivot point of the U-shaped rear leg frame 40 and the U-shaped front leg frame 50 respectively;
a plurality of serrated edge is mechanically coupled to the two side arms 110 for sliding process;
a slider locking mechanism mechanically coupled to the seat supporting frame 90 and the leg supporting frame 100 for mechanical adjustment;
a dental treatment unit 20, comprising:
a central body 140;
an integrated compressor and suction unit configured to provide dry air for dental treatment;
provide a pathway for suctioning out waste fluid;
a plurality of tubes 180 mechanically coupled to the central body 140, and configured to provide pathway for flow of fluid;
a detachable tool box 170 centrally fixed to the central body 140, and configured to store a plurality of equipment;
an adjustable handle 130 and a plurality of wheels 150 mechanically coupled to the central body 140, wherein the adjustable handle 130 and the plurality of wheels 150 is configured to provide easy mechanism to handle the central body 140; and
a ventilator unit 160 mechanically coupled to the side of the central body 140, and configured to ventilate the heated air out from the integrated compressor and suction unit.

2. The dental recliner chair 30 as claimed in claim 1, wherein the plurality of the serrated edge enables in adjusting of the two side arms 110 by sliding and hooking over the plurality of the serrated edges.

3. The dental recliner chair 30 as claimed in claim 1, wherein the slider locking mechanism enables various angular adjustment of the seat supporting frame 90 and the leg supporting frame 100.

4. The dental recliner chair 30 as claimed in claim 1, further comprises a spittoon bowl 230 and bottle 220 mechanically couple to the dental recliner chair 30, and configured to store saliva waste water.

5. The dental treatment unit 20 as claimed in claim 1, wherein the plurality of tubes 180 is connected to the corresponding plurality of equipment.

6. The dental treatment unit 20 as claimed in claim 5, wherein the plurality of equipment comprises a high-speed handpiece, a low-speed handpiece, 3-way syringe, saliva ejector, a plurality of bottle, wherein the plurality of bottle 190 comprises bottles from at least one of clean water system, air supply system and waste collection system.

7. The dental treatment unit 20 as claimed in claim 1, further comprises an electrical subsystem configured to provide electricity to the electrical driven systems, wherein the flow of electricity is controlled by a plurality of toggle switches.
